(19) United States
(12) Patent Application Publication
(10) Pub. No.: US 2026/0296588 A1
(43) Pub. Date: Oct. 1, 2026

(54) Sunshade Structure

(71) Applicant: Eagle Fan, Chu-Pei City (TW)

(72) Inventor: Eagle Fan, Chu-Pei City (TW)

(21) Appl. No.: 19/347,624

(22) Filed: Oct. 1, 2025

(30) Foreign Application Priority Data
Mar. 25, 2025 (CN) 2025205274162

(51) Int. Cl. B62J 50/21; B60J 3/02; B62J 17/086; B62J 45/00

(52) U.S. Cl. CPC B62J 50/225; B60J 3/0226; B62J 17/086; B62J 45/00

(57) ABSTRACT

A sunshade structure is provided, including: a carrier, a fan, a protective cover, and a sunshade, the carrier having a through hole penetrating therethrough, with two side areas of the carrier opposite to the through hole defined as a front area and a rear area; the fan being arranged in the carrier and corresponding to the position of the through hole, and the fan blowing air from the rear area to the front area through the through hole; the protective cover and the sunshade being pivoted to the carrier in a coaxial and layered manner, the protective cover being larger than the sunshade and located on the inside, and the two can be rotated individually, wherein the protective cover is made of a transparent material and can move to the front area, and the sunshade is made of a light-blocking material that can partially block the front area.

### TECHNICAL FIELD

The present disclosure relates generally to the technical field of sunshade for mobile phones on motorcycles, and more particularly, to a sunshade structure.

### BACKGROUND

Riders like to travel around on motorcycles during holidays and enjoy the feeling of speeding. Most riders install a clamping bracket on the motorcycle to use the mobile phone in a hand-free manner. In addition to providing navigation functions to unfamiliar destinations, the mobile phone applications can also be used to record the journey and play music at the right time to provide a more comfortable experience during driving.

However, in an environment with scorching sun, the sunlight directly shining on the mobile phone on the clamping bracket would hinder the rider from clearly seeing the displayed content. Therefore, the rider must adjust the mobile phone to backlight mode or block the sunlight with one hand in order to see the content clearly. To address the issue of not being able to see the content of the mobile phone clearly due to strong light, shading accessories for motorcycle clamping brackets have been also developed, but most currently available only have the single function of sunshade. In addition, numerous incidents, such as, the mobile phone may become overheated due to long-term use, or hit by flying stones during running, or becoming dirty due to flying insects or dirt attached to the surface of the mobile phone, remains potential threats to the damage of the mobile phone. Therefore, the present disclosure considers designing an improved structure to solve the above problems.

### SUMMARY

A primary objective of the present disclosure is to provide a sunshade structure, in particular a structure that can provide functions such as sunshade, protection and heat dissipation, so that riders can freely adjust and use according to actual conditions and needs, to provide better protection to the electronic products used on motorcycles, such as mobile phones or navigators.

To achieve the aforementioned objective, the present disclosure adopts the following technical solutions:

The present disclosure provides a sunshade structure, comprising: a carrier, a fan, a protective cover, and a sunshade, the carrier having a through hole penetrating therethrough, with the two side areas of the carrier opposite to the through hole respectively defined as a front area and a rear area; the fan being arranged in the carrier and corresponding to the position of the through hole, and the fan being used to blow air from the rear area to the front area through the through hole; the protective cover and the sunshade being pivoted to the carrier in a coaxial and layered manner, the protective cover being larger than the sunshade and located on the inside, and the two can be rotated individually to adjust the positions, wherein the protective cover is made of a transparent material and can move to the front area by rotation, and the sunshade is made of a light-blocking material that can partially block the front area by rotation.

As one of the preferred embodiments, when the protective cover rotates to the front area, the protective cover and the carrier form a non-enclosed space.

As one of the preferred embodiments, the carrier is further provided with an eave, which extends from the periphery of the carrier toward the front area.

As one of the preferred embodiments, the carrier has an accommodating groove on the side wall facing the rear area, a louver is installed in the accommodating groove, and the louver has a plurality of air passages for air to pass through.

As one of the preferred embodiments, an inner wall of the accommodating groove is disposed with a plurality of slots at several different positions respectively, and the outer wall around the louver is disposed with a plurality of blocks at corresponding positions at different positions; when the blocks are located in the slots, the louver is installed in the accommodating groove.

As one of the preferred embodiments, an angle positioning structure is provided at the pivotal joints of the protective cover, the sunshade, and the carrier, so that the protective cover and the sunshade can be stably fixed after being rotated and adjusted to a predetermined angle relative to the carrier.

As one of the better preferred embodiments, the angle positioning structure comprises a set of first annular teeth at two side walls of the carrier parallel to the through hole, and each of two sides of the protective cover comprises a supporting wall arranged face to face, the supporting wall has a set of first docking teeth on a wall surface facing the carrier and the other side wall surface has an annular groove, and a first spring is accommodated in the annular groove; when assembled, the supporting wall is attached to the side wall of the carrier, the first docking teeth are engaged with the first annular teeth, the first spring is located in the annular groove, and the two ends of the first spring are respectively against the protective cover and the sunshade.

As one of the better preferred embodiments, the angle positioning structure comprises a set of second annular teeth on the two side walls of the carrier parallel to the through hole, the sunshade is in an inverted U-shape with both sides extending downward to form a connecting wall, the connecting wall has a rotating shaft on the wall surface facing the carrier, the end surface of the rotating shaft has a set of second docking teeth, and the other side wall surface of the connecting wall has an axial groove, and a second spring is accommodated in the axial groove; when assembled, the connecting wall is attached to the protective cover, and a rivet penetrates the connecting wall and the side wall of the carrier so that the second docking teeth and the second annular teeth are engaged with each other, and the second spring is arranged on the periphery of the rivet and pushes into the axial groove.

As one of the preferred embodiments, the protective cover has a light transmittance of at least 80%.

As one of the preferred embodiments, the protective cover has a convex eave at an edge facing the wall of the sunshade, and the sunshade has a raised stopper at the edge close to the wall of the protective cover; when the protective cover is rotated to a vertical state, the convex eave contacts the stopper and links to move the sunshade.

Compared with the prior art, the sunshade structure of the present disclosure not only has the sunshade cover to achieve the sunshade function, but also includes a larger and more transparent protective cover. When the protective cover rotates and moves to the front area to provide protection to prevent external debris or dirt from entering, the clamping device located in the protective cover and the mobile phone fixed thereon can be well protected. In addition, the structure can also supply air to the front area in a timely manner through the fan to achieve a heat dissipation effect, thereby increasing the service life of the mobile phone.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a perspective view of the sunshade structure;

FIG. 2 is a cross-sectional view of the sunshade structure;

FIG. 3 is a view showing the sunshade of the sunshade structure in use;

FIG. 4 is a view showing another use state of the protective cover and the sunshade of the sunshade structure;

FIG. 5 is an exploded view of the sunshade structure;

FIG. 6 is a cross-sectional view of the angle positioning structure of the sunshade structure;

FIG. 7 is a first schematic view of the actual use of the sunshade structure;

FIG. 8 is a second schematic view of the actual use of the sunshade structure;

FIG. 9 is a third schematic view of the actual use of the sunshade structure.

FIG. 10 is a control flow for the manufacturing of the sunshade structure.

### DETAILED DESCRIPTION

The technical solutions of the present disclosure will be described clearly and completely below in conjunction with the specific embodiments and the accompanying drawings. It should be noted that when an element is referred to as being “mounted or fixed to” another element, it means that the element can be directly on the other element or an intervening element may also be present. When an element is referred to as being “connected” to another element, it means that the element can be directly connected to the other element or intervening elements may also be present. In the illustrated embodiment, the directions indicated up, down, left, right, front and back, etc. are relative, and are used to explain that the structures and movements of the various components in this case are relative. These representations are appropriate when the components are in the positions shown in the figures. However, if the description of the positions of elements changes, it is believed that these representations will change accordingly.

Unless otherwise defined, all technical and scientific terms used herein have the same meaning as commonly understood by one of ordinary skill in the art of the present invention. The terminology used herein is for the purpose of describing particular embodiments only and is not intended to limit the present invention. As used herein, the term “and/or” includes any and all combinations of one or more of the associated listed items.

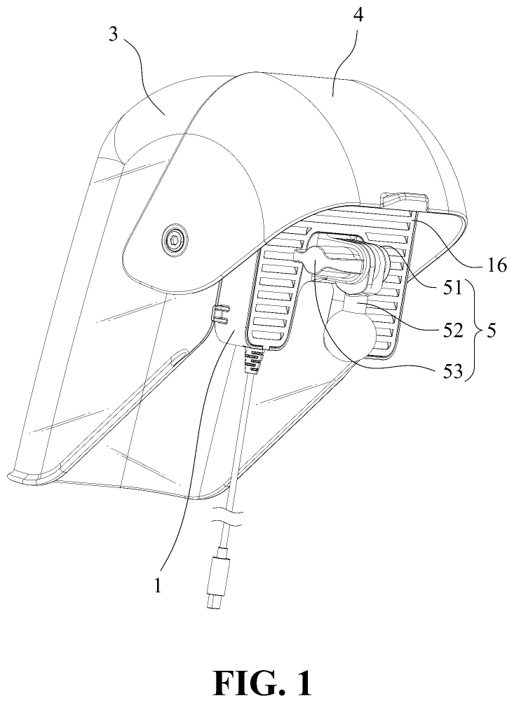

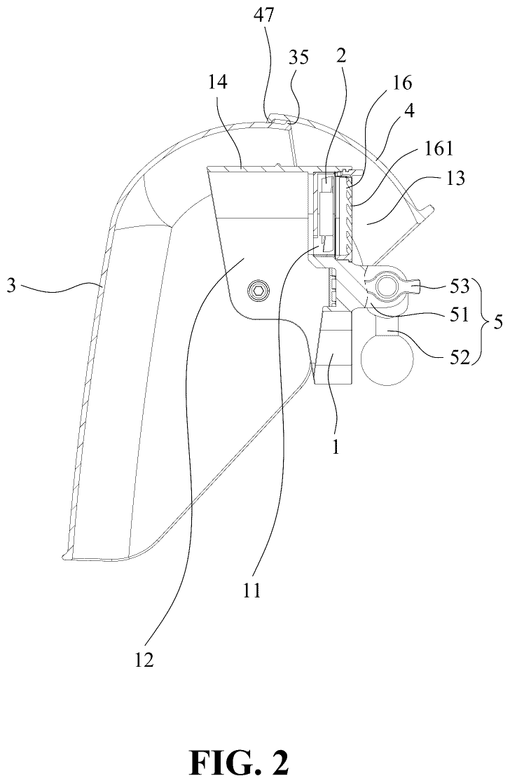

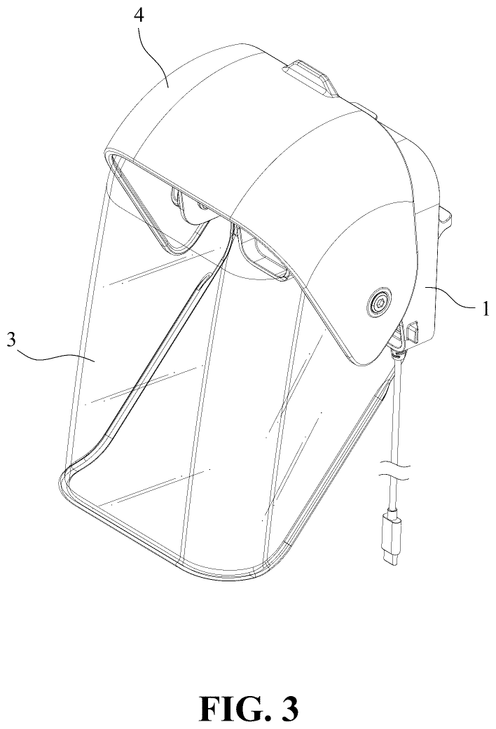

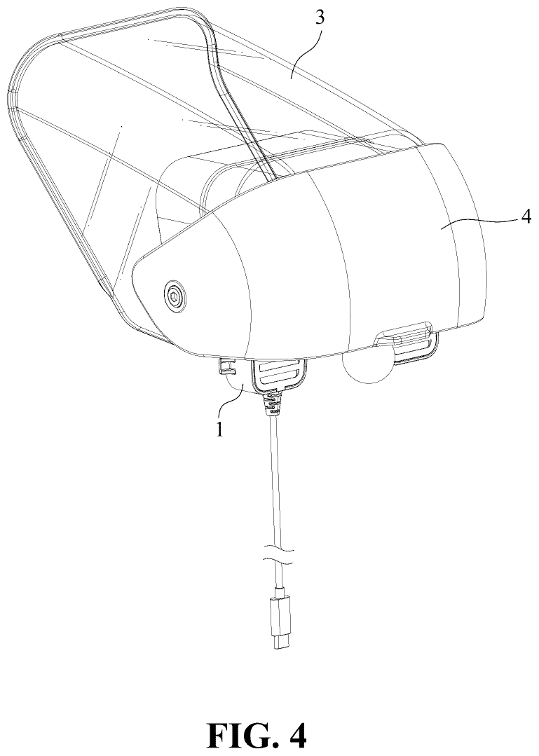

FIGS. 1 and 2 are a perspective view and a cross-sectional view of the sunshade structure, respectively. The sunshade structure of the present disclosure comprises a carrier 1, a fan 2, a protective cover 3, and a sunshade 4. The carrier 1 is provided with a through hole 11, and the two opposite sides of the carrier 1 at the through hole 11 are respectively defined as a front area 12 and a rear area 13; the fan 2 is arranged inside the carrier 1 and facing the through hole 11, and the fan 2 supplies air to the front area 12 of the carrier 1 through the through hole 11. The protective cover 3 and the sunshade 4 are pivoted to the carrier 1 in a coaxial and layered manner. The protective cover 3 is larger than the sunshade 4 and is located on the inside, and the two can be rotated individually to adjust the position respectively. The protective cover 3 is made of a transparent material and can be rotated to move to the front area 12 so that a non-enclosed space is formed between the protective cover 3 and the carrier 1. The space can be used for a clamping device or a clamped mobile phone to be placed therein. As shown in FIG. 3, the sunshade 4 can partially cover the front area 12 after being rotated to achieve the objective of shading without hindering the viewing of the items under the protective cover. As shown in FIG. 4, when not in use, the protective cover 3 is rotated to the upper position of the carrier 1, and the sunshade 4 is rotated to the rear area 13, so as not to hinder the placement or retrieval of the mobile phone. The sunshade structure of the present disclosure is installed on the handle of a motorcycle or a clamping device for a vehicle. The protective cover 3 and the sunshade 4 can respectively achieve the functions of protection and sunshade. The fan 2 can continuously supply air to the mobile phone in the front area 12 to achieve the function of heat dissipation, thereby meeting the different needs of users.

Next, a detailed description of the structure of the present disclosure is given:

The carrier 1 is used to carry the fan 2, the protective cover 3, and the sunshade 4, and can be installed on a bracket on a motorcycle through a connecting assembly 5. The connecting assembly 5 can be of various types and can be freely changed according to the needs of the user, thereby more convenient and easier to install in various brackets. In the present embodiment, the connecting assembly 5 includes a first connecting member 51, a second connecting member 52, and a knob 53. The first connecting member 51 extends from the carrier 1. One end of the first connecting member 51 is pivotally connected to the second connecting member 52. The knob 53 is installed at the pivot point of the first connecting member 51 and the second connecting member 52. By tightening the knob 53, the adjusted positions of the first connecting member 51 and the second connecting member 52 can be fixed. The end of the second connecting member 52 away from the first connecting member 51 is a spherical body, which is used to be pivotally connected to another ball seat for adjustment at more angles. In the present disclosure, the connecting assembly 5 is only for illustration, and not limited thereto.

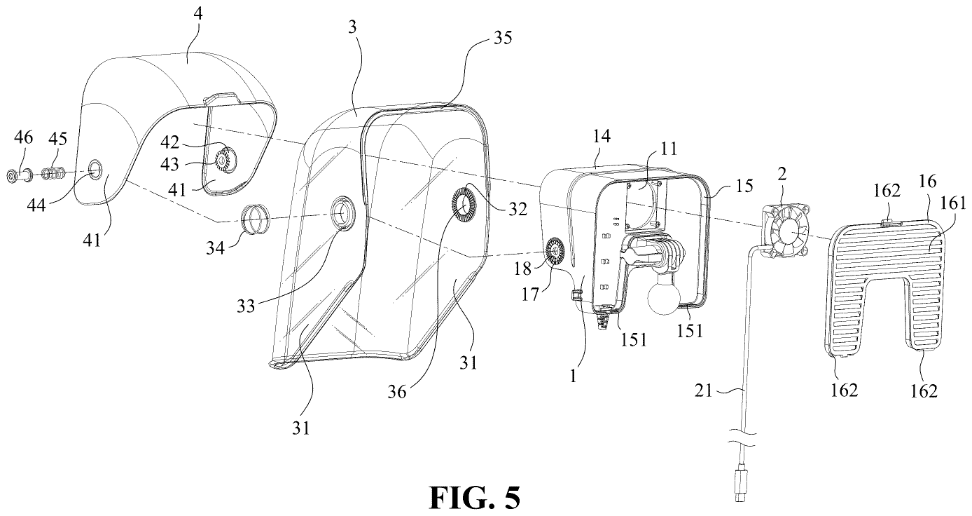

As shown in FIGS. 2 and 5, the structure of the carrier 1 is described. The through hole 11 penetrates the carrier 1. The front area 12 and the rear area 13 are respectively located on both sides of the carrier 1. The fan 2 allows air to flow from the rear area 13 to the front area 12 through the through hole 11. The carrier 1 further has an eave 14, which extends from the periphery of the carrier 1 toward the front area 12. In the present embodiment, the eave 14 provides an auxiliary sunshade effect. The carrier 1 has an accommodating groove 15 at the side wall facing the rear area 13. The accommodating groove 15 is for installing a louver 16 therein. The louver 16 has a plurality of air passages 161 for air to pass through. The plurality of air passages 161 are inclined passages and parallel to one another. The louvers 16 are used to prevent debris from directly contacting the fan 2, thereby extending the service life of the fan 2 and preventing debris from reaching the front area 12. In addition, in order to facilitate cleaning, an easy-to-detach structure is provided. The easy-to-detach structure comprises a plurality of slots 151 at several different positions on the inner wall of the accommodating groove 15. In the present embodiment, there are three slots 151, one on the upper wall surface and two on the lower wall surface. The outer wall around the louver 16 has a plurality of blocks 162 at corresponding positions at different positions. By combining the blocks 162 into the slots 151, the louver 16 can be quickly installed in the accommodating groove 15.

The protective cover 3 and the sunshade 4 are pivoted to the carrier 1 in a coaxial and layered manner and can rotate and move individually. In the present embodiment, the protective cover 3 and the sunshade 4 are coaxially pivoted to both sides of the eave 14. In order to ensure that the positions of the protective cover 3 and the sunshade 4 after rotation and adjustment can be temporarily fixed, an angle positioning structure is provided at the pivotal joints of the protective cover 3, the sunshade 4, and the carrier 1. The angle positioning structure is provided with a set of first annular teeth 17 and a set of second annular teeth 18 on the two side walls of the carrier 1 parallel to the through hole 11. The first annular teeth 17 and the second annular teeth 18 are arranged in concentric circles. The first annular teeth 17 are located on the outer circle, and the distribution angle of each tooth is smaller than the distribution angle of each tooth of the second annular teeth 18. For example, the first annular teeth 17 can be adjusted to an angle of 10 degrees each time, and the second annular teeth 18 can be adjusted to an angle of 15 degrees each time. The side wall of the carrier 1 has holes at the center of the first annular teeth 17 and the second annular teeth 18, and the holes are used for pivot connection.

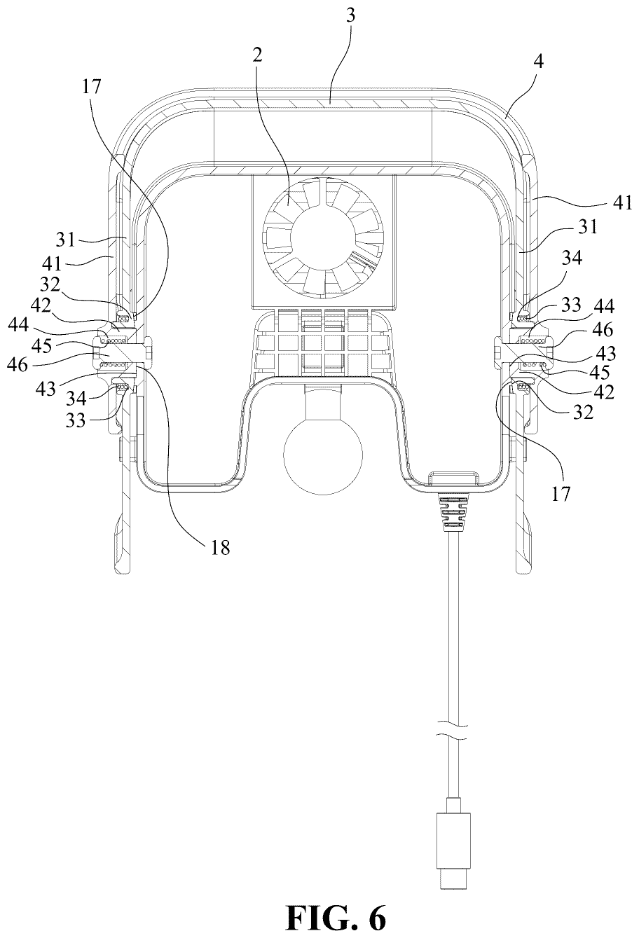

The protective cover 3 is made of a transparent material, and the light transmittance of the protective cover 3 is at least 80%, so that the user can still clearly see the items under the protective cover 3 from outside the cover. The protective cover 3 is larger than the sunshade 4 and can be moved to the front area 12 of the carrier 1 by rotation. The protective cover 3 can mostly cover the front area 12 to prevent foreign objects from falling directly into the front area 12. The protective cover 3 has a supporting wall 31 arranged face to face on both sides. The aforementioned angle positioning structure is that each of the supporting walls 31 has a set of first docking teeth 32 on the wall surface facing the carrier 1, and the other wall surface has an annular groove 33. A first spring 34 can be placed in the annular groove 33. The center position of the first docking teeth 32 has an axial hole 36. As shown in FIG. 6, during assembly, the supporting wall 31 is attached to the two side walls of the carrier 1, and first docking teeth 32 are engaged with the first annular teeth 17. The first spring 34 is located in the annular groove 33, and the two ends are respectively pressed against the protective cover 3 and the sunshade 4. When the user applies a force greater than the elastic force of the first spring 34, the protective cover 3 can be rotated. After the external force disappears, the first docking teeth 32 are engaged with the first annular teeth 17, so that the adjusted angle between the protective cover 3 and the carrier 1 is maintained. The edge of the protection cover 3 facing the sunshade 4 has a convex eave 35, and the convex eave 35 is used to link to move the sunshade 4.

The sunshade 4 is made of a light-proof material. The sunshade 4 is in an inverted U shape, with two connecting walls 41 extending downward on both sides. The connecting wall 41 has a rotating shaft 42 on the wall surface facing the carrier 1, and the end surface of the rotating shaft 42 has a set of second docking teeth 43, the other wall surface of the connecting wall 41 has an axis groove 44, and a second spring 45 is arranged in the axis groove 44. As shown in FIG. 6, when assembled, the sunshade 4 is attached to the supporting wall 31 of the protective cover 3 by the connecting wall 41, and a rivet 46 penetrates the connecting wall 41 and the eave 14 of the carrier 1 to achieve a pivotal effect, the rotating shaft 42 extends into the axis hole 36, and the second docking teeth 43 are engaged with the second annular teeth 18, and the second spring 45 is arranged on the periphery of the rivet 46 and pushes into the axis groove 44. When the user applies a force greater than the elastic force of the second spring 45, the sunshade 4 can be rotated. After the external force disappears, the second docking teeth 43 are engaged with the second annular teeth 18, so that the adjusted angle between the sunshade 4 and the carrier 1 is maintained. As shown in FIG. 2, the sunshade 4 has a raised stopper 47 near the edge of the wall of the protective cover 3. When the protective cover 3 is rotated to a vertical position, the convex eave 35 can contact the stopper 47, driving the sunshade 4 to rise slightly, so as to prevent the sunshade 4 from being too low in the rear area 13 and affecting the air suction effect of the fan 2.

The fan 2 is fixed to the inside of the carrier 1 by screws and faces the through hole 11. The fan 2 is provided with a connecting wire 21 extending to the outside to provide the power required for the operation of the fan 2.

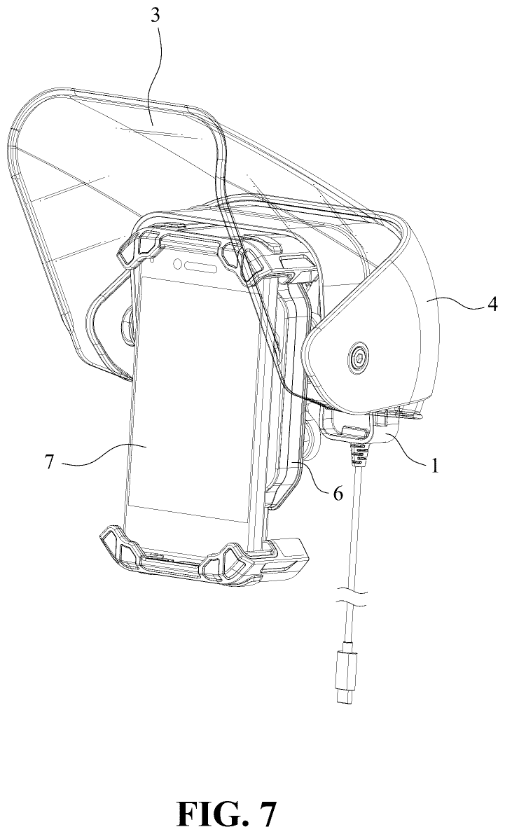

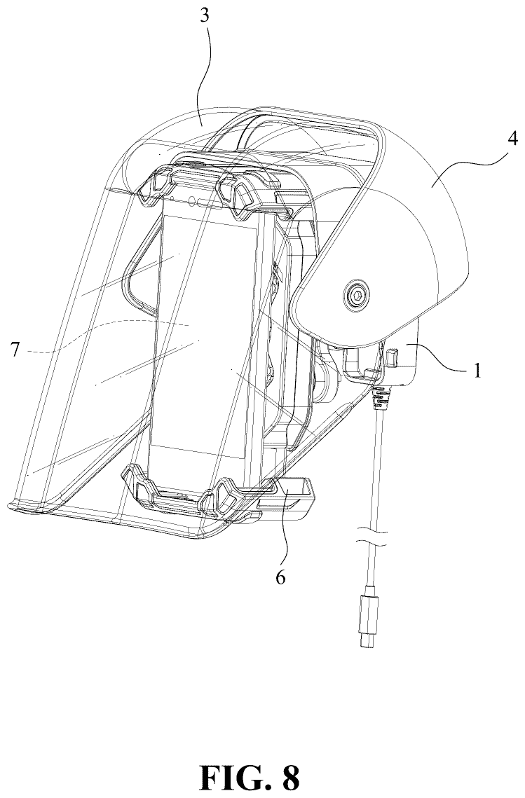

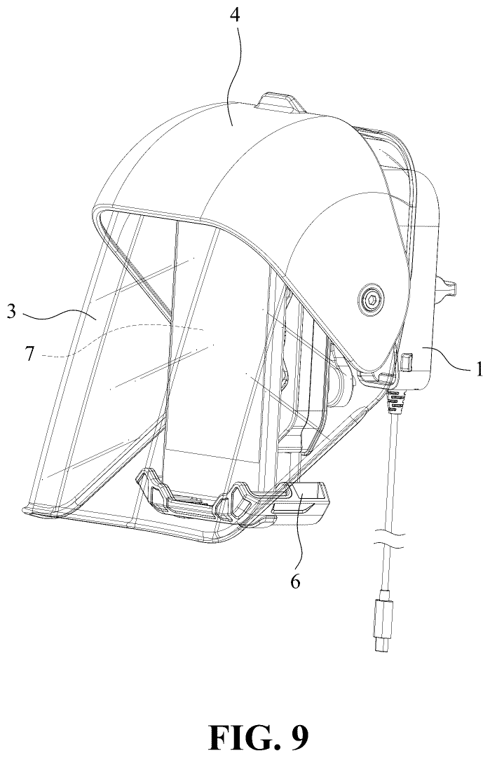

As shown in FIGS. 7, 8 and 9, they are schematic views of various usages of the sunshade structure. The sunshade structure of the present disclosure can be installed on a motorcycle in conjunction with a clamping device 6, and the motorcycle and the bracket structure connecting the clamping device 6 and the carrier 1 are not shown in the figure. The clamping device 6 is used to clamp a mobile phone 7. When in use, the clamping device 6 is located in the front area 12 of the carrier 1. As shown in FIG. 7, the protective cover 3 can be lifted up to be in a horizontal state, and the sunshade 4 can be rotated to the rear area 13. In this state, it is very convenient to take or place a mobile phone. As shown in FIG. 8, in an environment where sunlight is not strong, the protective cover 3 can be rotated to completely cover the front area 12, so that the clamping device 6 and the mobile phone 7 are located in the space enclosed by the protective cover 3 and the carrier 1. Because the protective cover 3 is transparent, the content displayed by the mobile phone 7 under the cover can be clearly seen, and the protective cover 3 is used to prevent foreign objects from directly contacting or dirtying the mobile phone 7. In addition, the fan 2 is operated at this time to send air from the rear area 13 to the front area 12 to achieve the function of heat dissipation. As shown in FIG. 9, when the sunlight is too strong, the sunshade 4 is rotated and adjusted to the front area 12 to block part of the light. Since the pivot joint has an angle positioning structure, the angle of the sunshade 4 can be accurately adjusted, so that the content displayed on the mobile phone 7 can be clearly seen in the case of sunshade. The sunshade structure of the present disclosure achieves multiple functions such as sunshade, protection, and heat dissipation to meet the different needs of users.

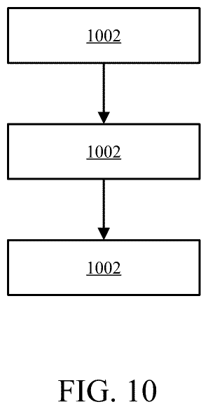

As shown in FIG. 10, therein is a control flow for the manufacturing of the sunshade structure. The control flow includes: providing a carrier, having a through hole penetrating therethrough, two side areas of the carrier are defined as a front area and a rear area in a block 1002; arranging a fan in the carrier corresponding to a position of the through hole, and the fan being used to blow air from the rear area to the front area through the through hole in a block 1004; and installing a protective cover and a sunshade, the protective cover and the sunshade being pivotally coupled to the carrier in a coaxial and layered manner, the protective cover being larger than the sunshade and located on an inside, the protective cover and the sunshade configured to be rotated individually, and the protective cover is made of a transparent material and moveable to the front area by rotation, and the sunshade is made of a light-blocking material and partially blocks the front area by rotation in a block 1006.

Although the sunshade structure has been described with reference to the preferred embodiments thereof, it is apparent to those skilled in the art that a variety of modifications and changes may be made without departing from the scope of the present invention which is intended to be defined by the appended claims.

Thus, it has been discovered that the sunshade structure furnishes important and heretofore unknown and unavailable solutions, capabilities, and functional aspects. The resulting configurations are straightforward, cost-effective, uncomplicated, highly versatile, accurate, sensitive, and effective, and can be implemented by adapting known components for ready, efficient, and economical manufacturing, application, and utilization.

The sunshade structure and methods can therefore provide multiple solutions including visibility of content displayed on the mobile phone clearly, overheating protection for to long-term use, and impact protection from flying stones, and cleanliness by protecting the phone from becoming dirty due to flying insects or dirt.

While the sunshade structure has been described in conjunction with a specific best mode, it is to be understood that many alternatives, modifications, and variations will be apparent to those skilled in the art in light of the preceding description. Accordingly, it is intended to embrace all such alternatives, modifications, and variations, which fall within the scope of the included claims. All matters set forth herein or shown in the accompanying drawings are to be interpreted in an illustrative and non-limiting sense.

What is claimed is:

1. A sunshade structure, comprising:
a carrier, having a through hole penetrating therethrough, two side areas of the carrier are defined as a front area and a rear area;
a fan, arranged in the carrier corresponding to a position of the through hole, and the fan being used to blow air from the rear area to the front area through the through hole;
a protective cover and a sunshade, the protective cover and the sunshade being pivotally coupled to the carrier in a coaxial and layered manner, the protective cover being larger than the sunshade and located on an inside, and the protective cover and the sunshade configured to be rotated individually; and
wherein the protective cover is made of a transparent material and is moveable to the front area by rotation, and the sunshade is made of a light-blocking material to partially block the front area by rotation.

2. The sunshade structure according to claim 1, wherein when the protective cover rotates to the front area such that the protective cover and the carrier form a non-enclosed space.

3. The sunshade structure according to claim 1, wherein the carrier is further provided with an eave which extends from a periphery of the carrier toward the front area.

4. The sunshade structure according to claim 1, wherein the carrier has an accommodating groove on a side wall facing the rear area, a louver is installed in the accommodating groove, and the louver has an air passage for the air to pass through.

5. The sunshade structure according to claim 4, wherein an inner wall of the accommodating groove is disposed with a plurality of slots at several different positions respectively, and an outer wall around the louver is disposed with a plurality of blocks at different positions, the louver is installed based on the plurality of blocks being located in the plurality of slots.

6. The sunshade structure according to claim 1, wherein an angle positioning structure is provided at a pivotal joint of the protective cover, the sunshade, and the carrier, such that the protective cover and the sunshade are stably fixed after being rotated and adjusted to a predetermined angle relative to the carrier.

7. The sunshade structure according to claim 6, wherein the angle positioning structure comprises a set of annular teeth at two side walls of the carrier parallel to the through hole, and each of two sides of the protective cover comprises a supporting wall arranged face to face, the supporting wall on each of the two sides has a set of docking teeth on a wall surface facing the carrier and the other side wall surface has an annular groove, and a spring is accommodated in the annular groove, the supporting wall on each of the two sides are attached to the two side walls of the carrier, the docking teeth are engaged with the annular teeth, the spring is located in the annular groove, and two ends of the spring are respectively against the protective cover and the sunshade.

8. The sunshade structure according to claim 6, wherein the angle positioning structure comprises a set of annular teeth on two side walls of the carrier parallel to the through hole, the sunshade is in an inverted U-shape with a side extending downward to form a connecting wall, the connecting wall has a rotating shaft on a wall surface facing the carrier, an end surface of the rotating shaft has a set of docking teeth, and another side wall surface of the connecting wall has an axial groove, and a spring is accommodated in the axial groove, the connecting wall is attached to the protective cover, and a rivet penetrates the connecting wall and one of the two side walls of the carrier so that the docking teeth and the annular teeth are engaged with each other, and the spring is arranged on a periphery of the rivet and pushes into the axial groove.

9. The sunshade structure according to claim 1, wherein the protective cover has a light transmittance of at least 80%.

10. The sunshade structure according to claim 1, wherein the protective cover has a convex eave at an edge facing a wall of the sunshade, and the sunshade has a raised stopper at the edge close to a wall of the protective cover; and the convex eave contacts the stopper and links to move the sunshade based on the protective cover being rotated to a vertical state.

11. A method of manufacturing a sunshade structure comprising:
providing a carrier, having a through hole penetrating therethrough, two side areas of the carrier are defined as a front area and a rear area;
arranging a fan in the carrier corresponding to a position of the through hole, and the fan being used to blow air from the rear area to the front area through the through hole; and
installing a protective cover and a sunshade, the protective cover and the sunshade being pivotally coupled to the carrier in a coaxial and layered manner, the protective cover being larger than the sunshade and located on an inside, the protective cover and the sunshade configured to be rotated individually, and the protective cover is made of a transparent material and moveable to the front area by rotation, and the sunshade is made of a light-blocking material and partially blocks the front area by rotation.

12. The method according to claim 11, wherein installing the protective cover includes installing the protective cover that rotates to the front area such that the protective cover and the carrier form a non-enclosed space.

13. The method according to claim 11, wherein providing the carrier includes providing the carrier with an eave which extends from a periphery of the carrier toward the front area.

14. The method according to claim 11, wherein providing the carrier includes providing the carrier with an accommodating groove on a side wall facing the rear area, a louver is installed in the accommodating groove, and the louver has an air passage for the air to pass through.

15. The method according to claim 14, wherein providing the carrier includes providing the carrier with an inner wall of the accommodating groove disposed with a plurality of slots at several different positions respectively, and an outer wall around the louver is disposed with a plurality of blocks at different positions, the louver is installed based on the plurality of blocks being located in the plurality of slots.

16. The method according to claim 11, further comprising providing an angle positioning structure at a pivotal joint of the protective cover, the sunshade, and the carrier, such that the protective cover and the sunshade are stably fixed after being rotated and adjusted to a predetermined angle relative to the carrier.

17. The method according to claim 16, wherein providing the angle positioning structure includes providing the angle positioning structure with a set of annular teeth at two side walls of the carrier parallel to the through hole, and each of two sides of the protective cover comprises a supporting wall arranged face to face, the supporting wall on each of the two sides has a set of docking teeth on a wall surface facing the carrier and another side wall surface has an annular groove, and a spring is accommodated in the annular groove, the supporting wall on each of the two sides are attached to the two side walls of the carrier, the docking teeth are engaged with the annular teeth, the spring is located in the annular groove, and two ends of the spring are respectively against the protective cover and the sunshade.

18. The method according to claim 16, wherein providing the angle positioning structure includes providing the angle positioning structure with a set of annular teeth on two side walls of the carrier parallel to the through hole, the sunshade is in an inverted U-shape with a side extending downward to form a connecting wall, the connecting wall has a rotating shaft on a wall surface facing the carrier, an end surface of the rotating shaft has a set of docking teeth, and another side wall surface of the connecting wall has an axial groove, and a spring is accommodated in the axial groove, the connecting wall is attached to the protective cover, and a rivet penetrates the connecting wall and one of the two side walls of the carrier so that the docking teeth and the annular teeth are engaged with each other, and the spring is arranged on the periphery of the rivet and pushes into the axial groove.

19. The method according to claim 11, wherein installing the protective cover includes installing the protective cover having a light transmittance of at least 80%.

20. The method according to claim 11, wherein installing the protective cover includes installing the protective cover having a convex eave at an edge facing a wall of the sunshade, and the sunshade has a raised stopper at the edge close to a wall of the protective cover; and the convex eave contacts the stopper and links to move the sunshade based on the protective cover being rotated to a vertical state.
